(19) United States
(12) Patent Application Publication
(10) Pub. No.: US 2025/0210727 A1
(43) Pub. Date: Jun. 26, 2025

(54) POWER STORAGE DEVICE, AND METHOD FOR MANUFACTURING POWER STORAGE DEVICE

(71) Applicant: Panasonic Intellectual Property Management Co., Ltd., Osaka (JP)

(72) Inventors: Masayuki TAKAGISHI, OSAKA FU (JP); Tetsuro EBINO, OSAKA FU (JP)

(21) Appl. No.: 18/730,689

(22) PCT Filed: Jan. 20, 2023
(86) PCT No.: PCT/JP2023/001604

§ 371 Date: Jul. 19, 2024

(30) Foreign Application Priority Data
Jan. 24, 2022 (JP) 2022-008693

(51) Int. Cl. H01M 10/42; H01G 11/50; H01G 11/56; H01G 11/84; H01M 10/0562; H01M 10/0585

(52) U.S. Cl. CPC H01M 10/4235; H01G 11/50; H01G 11/56; H01G 11/84; H01M 10/0562; H01M 10/0585; H01M 2300/0071; H01M 2300/0094

(57) ABSTRACT

A power storage device disclosed herein includes at least one first electrode in layer form, at least one second electrode in layer form, and at least one solid electrolyte layer disposed between the first electrode and the second electrode and including a first solid electrolyte. The electric storage device further includes a composite layer including a carbon material and a second solid electrolyte, at least one boundary selected from the group consisting of a first boundary between the first electrode and the solid electrolyte layer and a second boundary between the second electrode and the solid electrolyte layer.

### TECHNICAL FIELD

The present disclosure relates to a power storage device, and a method for manufacturing the power storage device.

### BACKGROUND ART

Capacitors using solid electrolytes and all-solid-state batteries have been disclosed in the past. PTL 1 (Japanese Laid-Open Patent Publication No. 2008-130844) discloses “an all-solid-state electric double layer capacitor including a solid electrolyte and a current collector, the solid electrolyte being an inorganic solid electrolyte”.

PTL 2 (Japanese Laid-Open Patent Publication No. 2017-147397) discloses “a capacitor including a base having a solid electrolyte layer including a solid electrolyte having lithium ion conductivity, and a first electrode and a second electrode arranged to face each other via the solid electrolyte layer, in which the first electrode is a first metal layer disposed on one main surface in a thickness direction of the solid electrolyte layer so as to be in contact with the one main surface, and the second electrode is made of a composite material including the solid electrolyte and a metal including nickel, and has, on the other main surface in the thickness direction of the solid electrolyte layer, a composite layer disposed in contact with the other main surface, and a second metal layer disposed to cover the composite layer”.

PTL 3 (Japanese Laid-Open Patent Publication No. 2019-087346) discloses “an all-solid-state battery including: a solid electrolyte layer made of an oxide-based solid electrolyte; a first electrode layer formed on one surface of the solid electrolyte layer and containing ceramic particles; and a second electrode layer formed on the other surface of the solid electrolyte layer and containing ceramic particles, in which at least one of the first electrode layer and the second electrode layer contains particulate carbon and plate-like carbon”.

### CITATION LIST

### Patent Literature

PTL 1: Japanese Laid-Open Patent Publication No. 2008-130844
PTL 2: Japanese Laid-Open Patent Publication No. 2017-147397
PTL 3: Japanese Laid-Open Patent Publication No. 2019-087346

### SUMMARY OF INVENTION

### Technical Problem

Currently, there is a demand for further improvement in the capacity density of a power storage device. An object of the present disclosure is to provide a power storage device having a high capacity density.

### Solution to Problem

An aspect of the present disclosure relates to a power storage device. The power storage device is a power storage device including: at least one first electrode in layer form; at least one second electrode in layer form; and at least one solid electrolyte layer disposed between the first electrode and the second electrode and including a first solid electrolyte, the power storage device further including a composite layer including a carbon material and a second solid electrolyte, at at least one boundary selected from the group consisting of a first boundary between the first electrode and the solid electrolyte layer and a second boundary between the second electrode and the solid electrolyte layer.

Another aspect of the present disclosure relates to a method for manufacturing the power storage device. The method for manufacturing the power storage device is a method for manufacturing a power storage device including a solid electrolyte layer and a composite layer adjacent to the solid electrolyte layer, the method including: a laminate forming step of forming a first laminate including a first mixture layer and a second mixture layer laminated on the first mixture layer; and a firing step of firing the first laminate to form a second laminate including the solid electrolyte layer and the composite layer, in which the solid electrolyte layer includes a first solid electrolyte, the composite layer includes a carbon material and a second solid electrolyte, the first mixture layer includes a material to become the solid electrolyte layer in the firing step, and the second mixture layer includes a material to become the composite layer in the firing step.

### Advantageous Effects of Invention

The present disclosure provides a power storage device having a high capacity density. Novel features of the present invention are described in the appended claims, but the present invention, both as to configuration and content, together with other objects and features of the present invention, will be better understood from the following detailed description taken in conjunction with the drawings.

### BRIEF DESCRIPTION OF DRAWINGS

FIG. 1 is a sectional view schematically illustrating a structure of a power storage device of a first embodiment.

FIG. 2 is a sectional view schematically illustrating a structure of a laminate produced in a working example.

### DESCRIPTION OF EMBODIMENTS

In the following, embodiments of a power storage device according to the present disclosure will be described using examples, but the present disclosure is not limited to the examples described below. In the following description, specific numerical values and materials may be exemplified, but other numerical values and materials may be applied as long as effects of the present disclosure are obtained. In the present specification, the expression “numerical value A to numerical value B” includes numerical value A and numerical value B and can be read as “numerical value A or more and numerical value B or less”. In the following description, when lower and upper limits of numerical values related to specific physical properties, conditions, or the like are exemplified, any of the exemplified lower limits and any of the exemplified upper limits can be arbitrarily combined as long as the lower limit is not equal to or greater than the upper limit. In the following description, the expression “including A” can include “a form substantially consisting of A” and “a form consisting of A”.

### (Power Storage Device)

The power storage device according to the present embodiment may be referred to hereinafter as a “power storage device (D)”. The power storage device (D) includes at least one first electrode in layer form, at least one second electrode in layer form, and at least one solid electrolyte layer disposed between the first electrode and the second electrode and including a first solid electrolyte. The power storage device (D) further includes a composite layer including a carbon material and a second solid electrolyte, at at least one boundary selected from the group consisting of a first boundary between the first electrode and the solid electrolyte layer and a second boundary between the second electrode and the solid electrolyte layer.

In the power storage device (D), during charging, it is believed that lithium ions (Li⁺) in the solid electrolyte layer move toward the negative electrode, that is to say the electrode to which the negative electrode of an external power supply is connected, and an electric double layer is formed between the negative electrode and the solid electrolyte layer. That is, it is believed that lithium ions gather near an interface of the solid electrolyte layer that faces the negative electrode, and electrons gather near an interface of the negative electrode that faces the solid electrolyte. On the other hand, during charging, it is believed that the electric double layer is formed at an interface between a positive electrode and solid electrolyte of the power storage device (D) by vacancies (negatively charged) from which lithium ions have been removed and vacancies (positive holes) in the positive electrode. As a result, power is stored in the power storage device (D). From one perspective, the power storage device (D) is a capacitor.

An all-solid-state battery described in PTL 3 is a battery that contains a positive electrode active material and a negative electrode active material. In contrast, the power storage device (D) is not a battery that contains a positive electrode active material and a negative electrode active material.

To increase the capacity density of a power storage device, it is important to increase the area of an interface between the electrode and the solid electrolyte layer. In the power storage device (D), the composite layer is disposed on at least a portion of the interface between the electrode and the solid electrolyte layer. This increases the area of the interface between the electrode and the solid electrolyte layer, so that the capacity density (for example, volumetric capacity density) can be increased.

Either the first electrode or the second electrode can be used as the positive electrode, and the other can be used as the negative electrode. That is, the power storage device (D) can be used as a power storage device that includes a positive electrode and a negative electrode. The composite layer is disposed at at least one boundary selected from the group consisting of a boundary between the positive electrode and the solid electrolyte and a boundary between the negative electrode and the solid electrolyte. The composite layer may be disposed only at the boundary between the positive electrode and the solid electrolyte layer, or may be disposed only at the boundary between the negative electrode and the solid electrolyte layer, or may be disposed at both of these two boundaries.

The power storage device (D) may satisfy either or both of the following conditions (1) and (2). By satisfying both the conditions (1) and (2), it is possible to particularly increase the capacity density.

(1) The first electrode is the positive electrode, and the composite layer is disposed only at the first boundary.

(2) The first solid electrolyte is a lithium-ion conductor, and the first solid electrolyte has a NASICON-type crystal structure and contains Li, Al, Ti, P, and O.

The solid electrolyte (lithium-ion conductor) having a NASICON-type crystal structure and containing Li, Al, Ti, P, and O is, for example, a solid electrolyte represented by a formula Li_{1+X}Al_{X}Ti_{2-X}(PO₄)₃ (X is, for example, in the range of 0.3 to 0.4), and may be a solid electrolyte represented by Li_{1.3}Al_{0.3}Ti_{1.7} (PO₄)₃. Solid electrolytes (compounds) represented by these formulas may be referred to as “LATP” below.

The specific surface area of the carbon material may be 30 m²/g or more. By using a carbon material having a specific surface area of 30 m²/g or more, the contact area between the electrode and the solid electrolyte layer can be increased. As a result, the capacity density can be increased. The specific surface area of the carbon material may be 10 m²/g or more. There is no particular upper limit to the specific surface area of the carbon material, but the specific surface area may be 2000 m²/g or less (for example, 1500 m²/g or less). Since carbon materials with various specific surface areas are commercially available, a commercially available carbon material that satisfies the above conditions may be used, or the carbon material may be produced according to a known method. The specific surface area can be measured by a BET method.

The first solid electrolyte and the second solid electrolyte may have different crystal structures. Alternatively, the first solid electrolyte and the second solid electrolyte may have the same crystal structure. For example, when the first solid electrolyte has a NASICON-type crystal structure (for example, in the case of the above condition (2)), the second solid electrolyte may also have a NASICON-type crystal structure. For example, the second solid electrolyte may be a lithium-ion conductor and have a NASICON-type crystal structure. In that case, the second solid electrolyte may contain Li, Al, Ti, P, and O.

The first solid electrolyte and the second solid electrolyte may be solid electrolytes made of the same raw material. By using the first and second solid electrolytes (for example, the same solid electrolyte) made of the same material, it is easier to form the electrolyte of the solid electrolyte layer and the solid electrolyte of the composite layer as an integrated unit. As a result, lithium-ion conductivity between the solid electrolyte layer and the composite layer can be increased. The first solid electrolyte and the second solid electrolyte may be different solid electrolytes or the same solid electrolyte.

The power storage device (D) may include a plurality of first electrodes, may include a plurality of second electrodes, and may include a plurality of solid electrolyte layers. For example, the power storage device (D) may include a plurality of first electrodes, a plurality of second electrodes, and a plurality of solid electrolyte layers. When the power storage device (D) includes a plurality of first electrodes and a plurality of second electrodes, the first electrodes and the second electrodes are typically arranged alternately. The solid electrolyte layer is disposed between first and second electrodes that are adjacent to each other.

There is no particular limitation on the number of first electrodes and the number of second electrodes, and they may be in the range of 1 to 1000 (for example, in the range of 2 to 100). The number of solid electrolyte layers arranged between the first electrodes and the second electrodes varies depending on the number of first and second electrodes and the structure of the power storage device (D).

The first electrode and the second electrode may be arranged only on the outside of a laminate including the solid electrolyte layer and the composite layer. Alternatively, the first electrode and the second electrode may be internal electrodes arranged inside the laminate including the solid electrolyte layer and the composite layer.

There is no particular limitation on the thickness of the solid electrolyte layer between the first electrode and the second electrode, and the thickness may be in the range of 1 to 30 μm (for example, in the range of 1 to 10 μm). There is no limitation on a thickness of the composite layer, and the thickness may be in the range of 1 to 30 μm (for example, in the range of 1 to 10 μm). When the first electrode and the second electrode are internal electrodes embedded in the solid electrolyte layer, the thickness of one internal electrode may be in the range of 1 to 10 μm (for example, in the range of 1 to 5 μm). Examples of the configuration and components of the power storage device (D) are described below. The configuration and components of the power storage device (D) are not limited to the following examples.

The power storage device (D) includes the first electrode, the second electrode, the solid electrolyte layer, and the composite layer. If necessary, the power storage device (D) may include other components, and may include a current collector and an exterior body. Typically, the first electrode, the second electrode, the solid electrolyte layer, and the composite layer are each in layer form. They are stacked to form the laminate.

### (Electrodes)

The first and second electrodes each have conductivity. The first and second electrodes can be formed of a material containing metal. Examples of the metal include Pd, Pt, Ag, Cu, Ni, Au, and other metals, and may be alloys.

The electrodes may be formed by vapor deposition or the like. Alternatively, the electrodes may be formed by applying a paste containing metal particles and then heating (for example, firing). A commercially available metal paste (for example, silver paste) may be used as the paste containing metal particles.

The first electrode and the second electrode may be formed of the same material. Alternatively, the first electrode and the second electrode may be formed of different materials.

### (Solid Electrolyte)

Examples of the solid electrolyte (first and second solid electrolytes) include solid electrolytes having lithium ion conductivity. The solid electrolyte is an inorganic solid electrolyte. The solid electrolyte may have a NASICON-type crystal structure and contain Li, Al, Ti, P, and O. Examples of such a solid electrolyte include the above-mentioned LATP.

### (Composite Layer)

The composite layer includes the solid electrolyte and the carbon material. The solid electrolytes described above may be used as the solid electrolyte. A carbon material having conductivity can be used as the carbon material. Examples of the carbon material include graphite (natural graphite, artificial graphite, and the like), carbon black (acetylene black, Ketjen black, and the like), carbon fiber, carbon nanotube, and graphene.

From one perspective, the carbon material of the composite layer can be considered to function as part of the electrode, and the solid electrolyte of the composite layer can be considered to function as part of the solid electrolyte layer. Therefore, it can be considered that the area of the interface between the electrode and the solid electrolyte layer can be increased by using the composite layer.

The composite layer may or may not contain components other than the solid electrolyte and the carbon material. A material having a specific surface area higher than that of metal fine particles can be used as the carbon material. Therefore, a preferred example of the composite layer does not contain metal fine particles such as nickel.

In the composite layer, a content Rs of the solid electrolyte may be in the range of 50 to 98 mass %, and a content Rc of the carbon material may be in the range of 2 to 50 mass %. The content Rs may be in the range of 80 to 98 mass % (for example, in the range of 90 to 95 mass %), and the content Rc may be in the range of 2 to 20 mass % (for example, in the range of 5 to 10 mass %).

When the power storage device (D) includes an exterior body, there are no limitations on the exterior body, and an exterior body similar to that used in electrolytic capacitors and batteries may be used. When the power storage device (D) includes a current collector, there are no limitations on the current collector, and a current collector similar to that used in the electrolytic capacitors and the batteries may be used.

### (Method for Manufacturing Power Storage Device)

A manufacturing method according to the present embodiment is described below. The manufacturing method may be referred to as “manufacturing method (M)” below. The manufacturing method (M) is a method for manufacturing the power storage device. With the manufacturing method (M), the power storage device (D) can be manufactured. Since the matters described about the power storage device (D) can be applied to the manufacturing method (M), duplicated descriptions may be omitted. Further, the matters described about the manufacturing method (M) may be applied to the power storage device (D). The power storage device (D) may be manufactured by a method other than the manufacturing method (M).

The manufacturing method (M) is a method for manufacturing the power storage device including the solid electrolyte layer and the composite layer adjacent to the solid electrolyte layer. The manufacturing method (M) includes a laminate forming step and a firing step in this order. These steps are described below.

### (Laminate Forming Step)

The laminate forming step is a step of forming a first laminate including a first mixture layer and a second mixture layer laminated on the first mixture layer. The solid electrolyte layer is the solid electrolyte layer described in the power storage device (D) and includes the first solid electrolyte. The composite layer is the composite layer described in the power storage device (D) and includes the carbon material and the second solid electrolyte. The first mixture layer includes a material to become the solid electrolyte layer in the firing step. The second mixture layer includes a material to become the composite layer in the firing step.

The material to become the solid electrolyte layer is a material that becomes the solid electrolyte when fired, and contains elements constituting the solid electrolyte. For example, when forming a solid electrolyte having a NASICON-type crystal structure and containing Li, Al, Ti, P, and O, the material can be, for example, a mixture of a lithium compound (such as Li₂CO₃), a phosphorus compound (such as AlPO₄ or H₃PO₄), an aluminum compound (such as AlPO₄ or Al₂O₃), and a Ti compound (such as TiO₂). The material to become the composite layer includes the material to become the solid electrolyte when fired and a carbon material. Note that as the material to become the solid electrolyte when fired, a powder form of the solid electrolyte may be used. A commercially available powder may be used as the powder form of the solid electrolyte. There is no particular limitation on the method for forming the first mixture layer and the second mixture layer, and they may be formed by a known method. For example, they may be formed by a method similar to that used in manufacturing a multilayer ceramic capacitor (MLCC).

The first layer may be formed by the following procedure. First, a material (for example, powder) for the solid electrolyte is mixed with a liquid medium. At this time, the material for the solid electrolyte is mixed in a predetermined ratio so that a desired solid electrolyte is formed when fired. Mixing (for example, pulverization mixing) can be performed by a known method such as a ball mill. The liquid medium, additives, and the like are added to the mixed powder obtained in this manner and kneaded to obtain a slurry. Examples of the additives include binders and plasticizers. The liquid medium and additives may be the same as those used in manufacturing the electrolytic capacitors and the batteries. Examples of the liquid medium include butyl acetate and the like. Examples of the binders include butyral resin and the like.

Subsequently, the first mixture layer is formed using the obtained slurry. Specifically, the first mixture layer can be formed by applying the slurry in a layer form and then drying and/or rolling as necessary. The second mixture layer can also be formed in the same manner as the first mixture layer. The first mixture layer and the second mixture layer are stacked to obtain the first laminate.

Note that the first laminate may be a laminate obtained by dividing the laminate formed by the above procedure.

### (Firing Step)

The firing step is a step of firing the first laminate to form a second laminate including the solid electrolyte layer and the composite layer. The second laminate (a fired body) in which the solid electrolyte layer and the composite layer are stacked is obtained by the firing step.

There is no particular limitation on firing conditions for the firing step as long as the second laminate (fired body) is obtained. The conditions for the firing step may be selected according to the type of the solid electrolyte. For example, the firing step is performed by performing heating at a temperature in the range of 500° C. to 1000° C. for 2 to 10 hours. The firing step is preferably performed in an inert atmosphere (for example, a nitrogen atmosphere). Before the firing step, a step of volatilizing the binders may be performed. For example, the first laminate may be heated in the atmosphere at a high temperature (for example, about 400° C.) for about 2 to 5 hours.

The second laminate is obtained in the above manner. Thereafter, electrodes and/or current collectors are formed as necessary to obtain a power storage element. The obtained power storage element is housed in the exterior body as necessary. In this manner, the power storage device is obtained.

The first laminate may include a plurality of the first mixture layers, a plurality of the second mixture layers, a plurality of first electrode material layers in layer form, and a plurality of second electrode material layers in layer form. That is, the laminate forming step may be a step of forming such a first laminate. In that case, the second mixture layer is disposed at at least one boundary selected from the group consisting of a boundary between a first mixture layer and a first electrode material layer, and a boundary between a first mixture layer and a second electrode material layer. Through the firing step, the first electrode material layers become first internal electrodes (first electrodes) and the second electrode material layers become second internal electrodes (second electrodes). According to this configuration, the second laminate including a plurality of first electrodes and a plurality of second electrodes is obtained. In this case, the manufacturing method (M) may further include a step of forming a first current collector connected to the first internal electrodes and a second current collector connected to the second internal electrodes.

There is no particular limitation on the step of forming the current collectors (first and second current collectors), and any known method may be applied. For example, the current collectors may be formed using a metal paste, or may be formed by a method such as vapor deposition. In addition, a plating layer may be formed on the formed current collectors.

The electrode material layers (the first electrode material layer and the second electrode material layer) may be formed from a material to become the electrode when fired. Examples of such a material include the above-mentioned paste containing metal particles.

An example of the power storage device (D) will be described in detail below with reference to the drawings. The components described above can be applied to the components of the power storage device in the examples described below. Further, the power storage device in the example described below can be modified based on the above description. Further, the matters described below may be applied to the above embodiment. Furthermore, in the embodiments described below, components that are not essential to the power storage device (D) may be omitted.

### First Embodiment

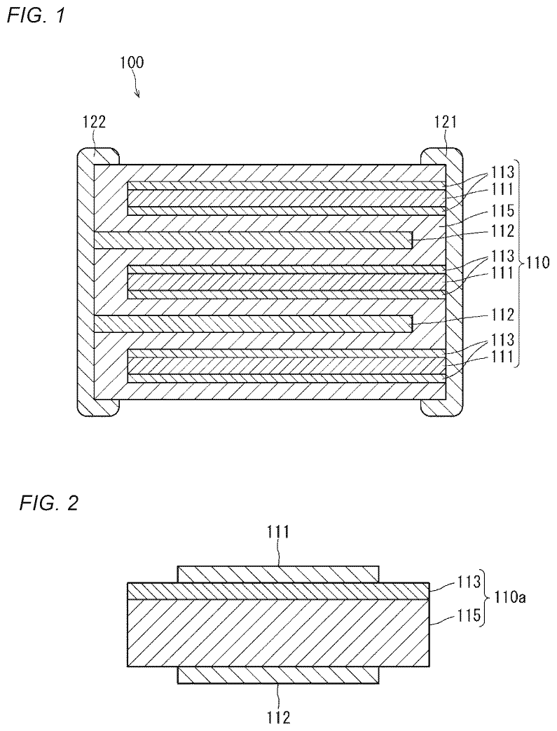

A sectional view of a power storage device 100 of a first embodiment is schematically illustrated in FIG. 1. The power storage device 100 includes a laminate (second laminate) 110. The laminate 110 includes a plurality of first electrodes (first internal electrodes) 111, a plurality of second electrodes (second internal electrodes) 112, composite layers 113, and a solid electrolyte layer 115. The power storage device 100 further includes a first current collector 121 and a second current collector 122. In the power storage device 100, the first electrodes 111 are positive electrodes, and the second electrodes 112 are negative electrodes.

The first electrodes 111 and the second electrodes 112 are arranged alternately. The solid electrolyte layer 115 is disposed in regions between the first electrodes 111 and the second electrodes 112. Ends of the plurality of first electrodes 111 on one side are connected to the first current collector (a positive electrode current collector) 121. Ends of the plurality of second electrodes 112 on one side are connected to the second current collector (a negative electrode current collector) 122.

Each of the composite layers 113 is disposed at the boundary between a first electrode 111 (positive electrode) and a solid electrolyte layer 115. The composite layer 113 is formed on each main surface of the first electrode 111 that faces a solid electrolyte layer 115. In the example illustrated in FIG. 1, the composite layer 113 is formed on both surfaces of the first electrode 111.

An example of the manufacturing method (M) for manufacturing the power storage device 100 will be described. In the following, an example in which LATP is used as the solid electrolyte will be described, but other solid electrolytes may also be used.

### (1) Formation of First Mixture Layer

First, predetermined amounts of raw materials are weighed and mixed. For example, when the lithium-ion conductor to be prepared is LATP, a Li compound such as Li₂CO₃, a P compound such as AlPO₄ or H₃PO₄, an Al compound such as AlPO₄ or Al₂O₃, and a Ti compound such as TiO are prepared as the raw materials. Then, the predetermined amounts of the raw materials are weighed and wet-mixed using the ball mill to obtain a mixture.

Subsequently, the resulting mixture is dehydrated and dried, and the dried powder is heat-treated to obtain a calcined powder of LATP. Subsequently, the resulting calcined powder is placed in a grinder (for example, ball mill) together with the liquid medium such as an organic solvent and wet-ground. The resulting powder is dried to obtain the ground powder of LATP. Note that as described above, a commercially available powder form of the solid electrolyte may also be used.

Subsequently, an organic binder such as butyral resin, a liquid medium mainly containing butyl acetate, and a plasticizer are added to the resulting powder and wet-mixed and dispersed to obtain a slurry. The resulting slurry is applied to a film (for example, PET film) by a doctor blade method and formed in a layer form to obtain an LATP green sheet (a first green sheet). The first green sheet corresponds to the first mixture layer.

### (2) Formation of Electrode Layer and Composite Layer

A paste to become the composite layer is printed in a predetermined pattern on the LATP green sheet by screen printing. The paste contains the LATP ground powder and a carbon material powder. In this manner, a second mixture layer to become the composite layer is formed. Subsequently, an electrode paste to become the first electrode 111 is printed on the second mixture layer to form the first electrode material layer. Furthermore, the second mixture layer is formed again on the first electrode material layer. In this manner, a second green sheet is obtained in which the second mixture layer, the first electrode material layer, and the second mixture layer are laminated on a part of the first mixture layer.

Further, the second electrode material layer is formed by printing the electrode paste to become the second electrode 112 on the LATP green sheet by screen printing. In this manner, a third green sheet is obtained in which the second electrode material layer is formed on a part of the first mixture layer.

### (3) Formation of Laminate

Subsequently, the first to third green sheets are laminated to form the laminate (first laminate). When forming the laminate 110 (the second laminate) illustrated in FIG. 1, the first laminate is formed by laminating the second green sheet, the third green sheet, the second green sheet, the third green sheet, the second green sheet, and the first green sheet in this order. Subsequently, the obtained first laminate is cut to a desired size to obtain a plurality of unfired elements (first laminates).

### (4) Firing Step

Subsequently, the resulting unfired element is heated in the atmosphere at 400° C. for 2 to 5 hours to remove the organic binder. Thereafter, the unfired element is fired under predetermined firing conditions in a nitrogen atmosphere. In this manner, the second laminate (power storage element) is obtained.

### (5) Current Collector Forming Step

Subsequently, the metal paste to become external electrodes is applied to both end surfaces of the second laminate, and fired under predetermined conditions in a nitrogen atmosphere to form the current collectors (external electrodes). The metal paste contains a metal powder of a metal such as Ag, Cu, Ni, Pt, Pd, an Ag—Pd alloy, or an Ag—Pt alloy. If necessary, a plating layer may be formed on the current collectors. For example, a Ni layer (foundation layer) and a Sn layer (surface layer) may be formed by plating.

The power storage device 100 can be manufactured in the above manner. Note that the power storage device (D) may be manufactured by other methods. For example, the first laminate may be formed by stacking material layers in order. Alternatively, the power storage device (D) may be manufactured by a method described in the following Working Examples section.

### WORKING EXAMPLES

The power storage device according to the present disclosure will be described in more detail using working examples. In this example, a plurality of the power storage devices were prepared and evaluated by the following method.

### (Device A1)

A device A1 (power storage device) was prepared by the following method. LATP powder manufactured by Toshima Manufacturing Co., Ltd. was used as the material for the solid electrolyte. 15 mol % of Li₂CO₃ powder was added as a sintering aid to the LATP powder, and the organic binder was further added and mixed to obtain a first mixed powder.

As the powder of the carbon material contained in the composite layer, KETJENBLACK EC600JD manufactured by Lion Specialty Chemicals Co., Ltd. was used. This carbon material was added to the first mixed powder to obtain a second mixed powder. The ratio of the carbon material to the total of the LATP powder and the carbon material was 5 mass %.

The first mixed powder and the second mixed powder were sequentially introduced into a cylindrical mold with an inner diameter of 13 mm. Subsequently, press molding was performed at a pressure of 1 ton/cm² to obtain a disk-shaped pellet (the first laminate). The obtained pellet was heated at 400° C. in the atmosphere to volatilize the organic binder. Thereafter, the pellet was fired at 800° C. in a nitrogen atmosphere to obtain a sintered body (the second laminate). Through the firing, the first mixed powder became the solid electrolyte layer and the second mixed powder became the composite layer. Note that the pellets were prepared such that thicknesses of the solid electrolyte layer and the composite layer after firing were as shown in Table 1.

In this manner, a second laminate 110a illustrated in FIG. 2 was obtained. The laminate 110a in FIG. 2 includes the solid electrolyte layer 115 and the composite layer 113 laminated on the solid electrolyte layer 115.

Subsequently, as illustrated in FIG. 2, the first electrode 111 and the second electrode 112 made of gold were formed by sputtering on both sides of the obtained laminate 110a. The electrodes were circular (diameter 8.5 mm). In this manner, the power storage device (the device A1) was obtained. Note that the first electrode 111 was used as the positive electrode, and the second electrode 112 was used as the negative electrode.

### (Device A2)

A device A2 was prepared under the same conditions and by the same method as for preparing the device A1, except that the composite layer was placed only on the second electrode 112 side (negative electrode side).

### (Device A3)

A device A3 was prepared under the same conditions and by the same method as for preparing the device A1, except that composite layers were placed on both sides of the solid electrolyte layer 115.

### (Device A4)

A device A4 was prepared under the same conditions and by the same method as for preparing the device A1, except that the composite layers were placed on the both sides of the solid electrolyte layer 115 and the thickness of the composite layer was changed.

### (Device C1)

A device C1 was prepared under the same conditions and by the same method as for preparing the device A1, except that no composite layer was formed.

### (Evaluation of Power Storage Device)

The volumetric capacity density of the power storage device was evaluated by the following method. First, the prepared power storage device was charged at a constant voltage of 0.5 V for 5 minutes. Thereafter, the power storage device was discharged at a current value of 10 μA, and a discharge capacity C (F) at that time was measured. The discharge capacity C was calculated using the following formula.

$$C = t \cdot I / Δ V$$

t: Discharge time (sec)
I: Discharge current (A)
ΔV: Discharge start voltage (V)-discharge end voltage (V)

The volumetric capacity density (mF/cm³) was calculated by dividing the measured discharge capacity by the volume of the power storage element. Some manufacturing conditions for the power storage devices and evaluation results are shown in Table 1. Note that in the device A3, the thickness of the composite layer on the positive electrode side and the thickness of the composite layer on the negative electrode side were each 0.185 mm. In the device A4, the thickness of the composite layer on the positive electrode side and the thickness of the composite layer on the negative electrode side were each 0.278 mm.

TABLE 1

| | | Thickness (mm) | | Volumetric |
|---|---|---|---|---|
| | | Solid | | capacity |
| | | electrolyte | Composite | density |
| Device | Composite layer | layer | layer | (mF/cm³) |
| A1 | Only positive | 0.7 | 0.185 | 13.6 |
| | electrode side | | | |
| A2 | Only negative | 0.7 | 0.185 | 7.2 |
| | electrode side | | | |
| A3 | Both sides | 0.7 | 0.185/0.185 | 9.1 |
| A4 | Both sides | 0.7 | 0.278/0.278 | 11.1 |
| C1 | None | 0.7 | None | 1.0 |

As shown in Table 1, the devices A1 to A4 in which the composite layer was formed had a significantly higher volumetric capacity density than the device C1 of Comparative Example.

The device A1 in which the composite layer was formed on the positive electrode side had a higher volumetric capacity density than the device A2 in which the composite layer was formed on the negative electrode side. The reason for this is not clear at present, but can be thought to be as follows. In the power storage device (D), it can be thought that a first electric double layer is formed at the interface between the positive electrode and the solid electrolyte layer, and a second electric double layer is formed at the interface between the negative electrode and the solid electrolyte layer. Here, the capacity of the first electric double layer is Cp, and the capacity of the second electric double layer is Cn. As described above, during charging, the vacancies from which lithium ions have been removed are formed in the solid electrolyte facing the positive electrode to form the first electric double layer. However, in LATP, there is a possibility that the capacity Cp is reduced due to charge compensation near the electric double layer associated with change in valence of Ti ions in LATP. That is, when LATP is used as the solid electrolyte, there is a possibility that Cp<Cn. Therefore, there is a possibility that the volumetric capacity density could be particularly increased by forming the composite layer on the positive electrode side to increase Cp. Such an effect may be a phenomenon specific to a specific solid electrolyte layer such as LATP, and may not occur, for example, in the solid electrolytes such as Li₇La₃Zr₂ and Li₃ₓLa_{2/3-x}TiO₃.

### INDUSTRIAL APPLICABILITY

The present disclosure is applicable to a power storage device and a method for manufacturing the power storage device.

Although the present invention has been described in terms of presently preferred embodiments, such disclosure should not be construed as limiting. Various modifications and alterations will no doubt become apparent to those skilled in the art to which the present invention pertains upon reading the above disclosure. Accordingly, the appended claims should be construed as including all modifications and alterations without departing from the true spirit and scope of the present invention.

### REFERENCE SIGNS LIST

100: power storage device, 110, 110a: laminate (second laminate), 111: first electrode, 112: second electrode, 113: composite layer, 115: solid electrolyte layer

1. A power storage device comprising:
at least one first electrode in layer form;
at least one second electrode in layer form; and
at least one solid electrolyte layer disposed between the first electrode and the second electrode and including a first solid electrolyte,
the power storage device further comprising a composite layer including a carbon material and a second solid electrolyte, at at least one boundary selected from the group consisting of a first boundary between the first electrode and the solid electrolyte layer and a second boundary between the second electrode and the solid electrolyte layer.

2. The power storage device according to claim 1, wherein
the first electrode is a positive electrode, and
the composite layer is disposed only at the first boundary.

3. The power storage device according to claim 1, wherein
the first solid electrolyte is a lithium ion conductor, and
the first solid electrolyte has a NASICON-type crystal structure and contains Li, Al, Ti, P, and O.

4. The power storage device according to claim 1, wherein a specific surface area of the carbon material is 30 m²/g or more.

5. The power storage device according to claim 1, wherein the first solid electrolyte and the second solid electrolyte have the same crystal structure.

6. The power storage device according to claim 1, comprising a plurality of the first electrodes and a plurality of the second electrodes.

7. A method for manufacturing a power storage device including a solid electrolyte layer and a composite layer adjacent to the solid electrolyte layer, the method comprising:
a laminate forming step of forming a first laminate including a first mixture layer and a second mixture layer laminated on the first mixture layer; and
a firing step of firing the first laminate to form a second laminate including the solid electrolyte layer and the composite layer, wherein
the solid electrolyte layer includes a first solid electrolyte,
the composite layer includes a carbon material and a second solid electrolyte,
the first mixture layer includes a material to become the solid electrolyte layer in the firing step, and
the second mixture layer includes a material to become the composite layer in the firing step.

8. The method for manufacturing the power storage device according to claim 7, wherein
the first laminate includes a plurality of the first mixture layers, a plurality of the second mixture layers, a plurality of first electrode material layers in layer form, and a plurality of second electrode material layers in layer form,
each of the second mixture layers is disposed at at least one boundary selected from the group consisting of a boundary between the first mixture layer and the first electrode material layer, and a boundary between the first mixture layer and the second electrode material layer,
through the firing step, the first electrode material layers become first internal electrodes and the second electrode material layers become second internal electrodes, and
the method further comprises a step of forming a first current collector connected to the first internal electrodes and a second current collector connected to the second internal electrodes.

9. The method for manufacturing the power storage device according to claim 8, wherein
the first internal electrodes are positive electrodes, and
the second mixture layer is disposed only at the boundary between the first mixture layer and the first electrode material layer.

10. The method for manufacturing the power storage device according to claim 7, wherein
the first solid electrolyte is a lithium ion conductor, and
the first solid electrolyte has a NASICON-type crystal structure and contains Li, Al, Ti, P, and O.

11. The method for manufacturing the power storage device according to claim 7, wherein a specific surface area of the carbon material is 30 m²/g or more.

12. The method for manufacturing the power storage device according to claim 7, wherein the first solid electrolyte and the second solid electrolyte have the same crystal structure.
